(19) United States
(12) Patent Application Publication
(10) Pub. No.: US 2017/0142313 A1
(43) Pub. Date: May 18, 2017

(54) IMAGE SENSOR SYSTEM

(71) Applicant: Microsoft Technology Licensing, LLC, Redmond, WA (US)

(72) Inventors: Juuso Petteri Gren, London (GB); Eero Juho Kustavi Tuulos, London (GB); Mikko Muukki, London (GB); Samu Koskinen, London (GB)

(73) Assignee: Microsoft Corporation

(21) Appl. No.: 14/942,857

(22) Filed: Nov. 16, 2015

(51) Int. Cl. H04N 5/235; H04N 5/376; H04N 5/378

(52) U.S. Cl. CPC H04N 5/2353; H04N 5/378; H04N 5/3765

(57) ABSTRACT

An image sensor system comprises a plurality of image sensing pixels which are arranged in lines. Control circuitry in the image sensor system is configured, when capturing a single image, to set an exposure time for the image sensing pixels in a line such that a first group of pixels in the line has a first exposure time and a second group of pixels in the same line has a second exposure time.

### BACKGROUND

The dynamic range of image sensors is much smaller than that of the human visual system. This means that images of scenes with a large dynamic range (e.g. due to shadows and/or very bright regions) will have parts where no details are visible (e.g. because the image is very dark or saturated), even if those details are visible to the user who is capturing the image.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

An image sensor system comprises a plurality of image sensing pixels which are arranged in lines. Control circuitry in the image sensor system is configured, when capturing a single image, to set an exposure time for the image sensing pixels in a line such that a first group of pixels in the line has a first exposure time and a second group of pixels in the same line has a second exposure time.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an example array of image sensing pixels;

FIG. 2 is a schematic diagram of an example image sensor system;

FIG. 3 is a flow diagram showing an example method of operation of the image sensor system shown in FIG. 2;

FIG. 4 is a flow diagram showing an example method which is an example implementation of the method of FIG. 3;

FIG. 5 is a flow diagram showing another example method which is an example implementation of the method of FIG. 3;

FIG. 6 is a flow diagram showing a further example method which is an example implementation of the method of FIG. 3;

FIG. 7 is a graphical representation of an example implementation of the method of FIG. 6; and

FIG. 8 is a flow diagram showing another example method which is an example implementation of the method of FIG. 3.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

There are a number of existing high dynamic range (HDR) techniques; however, some techniques can result in unwanted visual artifacts (e.g. blurring or disjointed objects) and other techniques reduce the resolution of the whole of the resulting image whilst typically providing benefits for less than half of the image. The embodiments described below are not limited to implementations which solve any or all of the disadvantages of known image sensor systems.

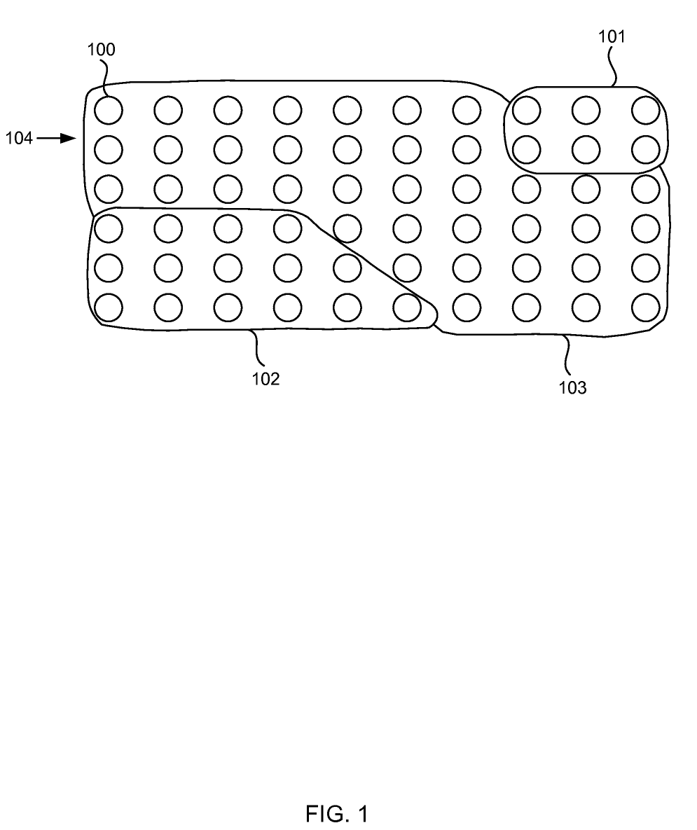

An image sensor system is described herein which comprises control circuitry which is configured to set a plurality of exposure times within a single line of image sensing pixels. Pre-capture data may be used to divide the array of image sensing pixels 100 in the image sensor into a plurality of regions 101-103 based on the brightness of those parts of the image (as determined from the pre-capture data), as shown graphically in FIG. 1. A first exposure time can be used for pixels in the first region 101, a second exposure time for the image sensing pixels in the second region 102 and a third exposure time for the image sensing pixels in the third region 103. FIG. 1 shows an array of 10×6 image sensing pixels by way of example only and it will be appreciated that an image sensing array will typically comprise many more image sensing pixels (e.g. millions of pixels).

The pre-capture data which is used to divide the array of image sensing pixels in the image sensor into a plurality of regions may, for example, be live preview or viewfinder data, which may comprise a plurality frames. In some examples, the pre-capture data may be visible to the end user and in other examples, the pre-capture is not visible to the end user. In various examples, the pre-capture data is captured after the camera is activated and before the display shows a preview image.

The dividing of the image sensing pixels into groups with different exposure times (using the pre-capture data) is therefore based on the image content and in the examples shown, the first region 101 might correspond to the sun in the sky, the second region 102 might correspond to the sky itself and the third region 103 might correspond to a shadow on the ground. In such an example the first exposure time may be the shortest of the three exposure times and the third exposure time may be the longest of the three exposure times.

Having divided the image sensing pixels into regions, within at least one of the lines of image sensing pixels in the array, there will be a first group (i.e. proper subset) of the image sensing pixels that have one exposure time and a second group (i.e. a second proper subset) of the image sensing pixels that have another exposure time (i.e. the first and second groups are part of different regions) and in the example shown in FIG. 1 this is the case for all but one of the lines of image sensing pixels. The second line in the array (indicated by arrow 104) comprises a first group comprising 7 image sensing pixels which are in the third region 103 and have the third exposure time and a second group comprising 3 image sensing pixels which are in the first region and have the first exposure time.

This dividing of lines of image sensing pixels into groups with different exposure times, as shown in FIG. 1, enables the exposure time to be closely matched to the light levels in the scene to be captured.

Although the example above uses three regions and three different exposure times, there may only be two different exposure times or there may be more than three different exposure times. Each different exposure time corresponds to a different region in the image; however, there may be more than one region with the same exposure time (i.e. if there are E exposure times, where E>1, there are R regions, where R≧E). For example, there may be two non-adjacent regions with the same exposure time (e.g. referring back to FIG. 1, regions 101 and 103 may have a first exposure time and region 102 may have a second exposure time). At an extreme, each image sensing pixel may be considered to be a separate region, such that per-pixel exposure times are defined; although there may be many fewer exposure times used than the number of image sensing pixels in the array (i.e. in this example, R>>E). At the opposite extreme, there may only be two regions and two possible exposure times (i.e. in this example R=E=2).

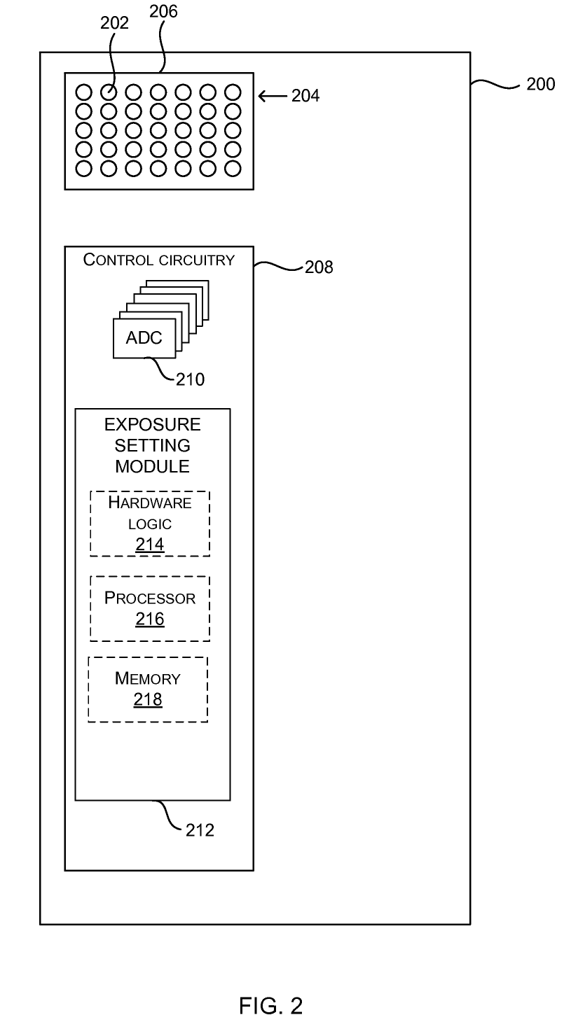

FIG. 2 is a schematic diagram of an example image sensor system 200 which may, for example, be used within a mobile telephone, tablet computer, games console, digital camera, etc. The image sensor system 200 comprises a plurality of image sensing pixels 202 (referred to hereafter as ‘pixels’) arranged in lines 204 and which collectively may be referred to as the pixel array 206. The pixels 202 may be frontside-illuminated sensors or backside-illuminated sensors. The system 200 also comprises control circuitry 208 which is electrically connected to the pixel array 206 and controls the exposure of pixels 202 within the array, e.g. it may control the start and/or the end of the exposure time and the end of the exposure time may correspond to the time when a pixel is read, or alternatively the control circuitry 208 may additionally control when data (e.g. a charge level) is read from each pixel.

The control circuitry 208 comprises a plurality of analog to digital converters (ADCs) 210 and depending upon the implementation, there may be one ADC per column of pixels, one ADC per pixel or one ADC per group of pixels in a line. These ADCs are used to read data from each pixel in the array. The control circuitry 208 also comprises an exposure setting module 212 which divides the pixels into the two or more regions and sets the exposure times (and potentially other exposure parameters) for the different regions (where these exposure times may be selected from a set of possible exposure times or may be determined dynamically based on analysis of a pre-captured image). The exposure setting module 212 may comprise hardware logic 214 and/or a processor 216.

In examples where the exposure setting module 212 comprises a processor 214, the processor 214 may be a microprocessor, controller or any other suitable type of processor for processing computer executable instructions to control the operation of the device in order to divide the pixels into two or more regions (based on pre-capture data) and define an exposure time for each region (e.g. based on the pre-capture data and/or a pre-defined set of possible exposure times or exposure time ratios). In some examples, for example where a system on a chip architecture is used, the processor 214 may include one or more fixed function blocks (also referred to as accelerators) which implement a part of the method of dividing the pixels into regions and/or defining exposure times in hardware (rather than software or firmware). The exposure setting module 212 (or, more generally, the control circuitry 208) may further comprise a memory 218 arranged to store computer executable instructions which are executed by the processor 214 and which, when executed, cause the processor 214 to divide the array of pixels into regions and set an exposure time for each region.

Alternatively, or in addition, the functionality described herein can be performed, at least in part, by one or more hardware logic components 214. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

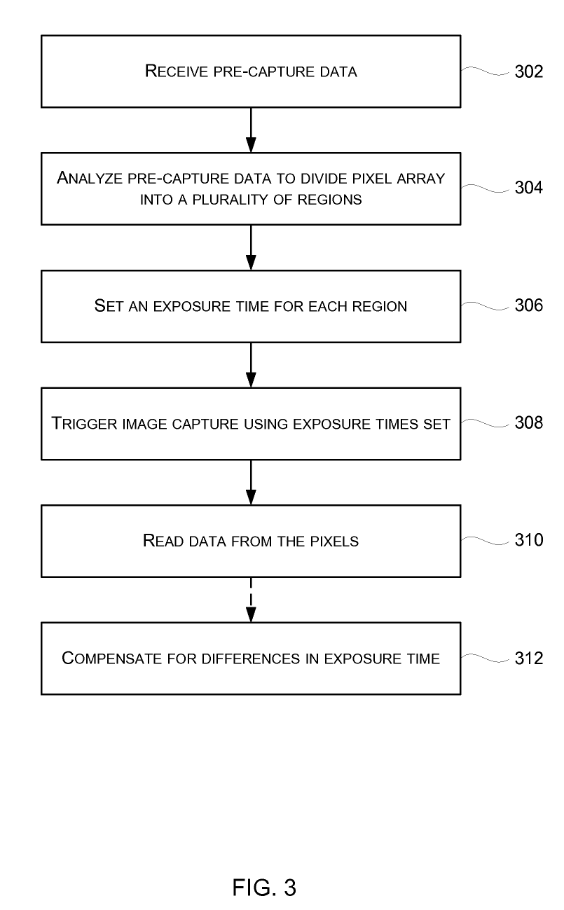

The operation of the control circuitry 208 can be described with reference to the flow diagram shown in FIG. 3. Pre-capture data (e.g. live preview or viewfinder data, which may comprise a plurality of frames) is received (block 302) and analyzed to divide the pixel array into a plurality of regions (block 304), where these regions are based on the dynamic range in the pre-capture data and do not need to comprise entire lines of pixels in the array. Whilst a region may comprise an entire line of pixels, at least one line in the array is divided such that one or more of the pixels are in one region and one or more other pixels in the line are in a different region.

In various examples, a line-by-line exposure variation technique (with alternate lines of pixels using different exposure times, but all the pixels in a line having the same exposure time) may be used during the pre-capture (i.e. when generating the pre-capture data which is received in block 302) in order to provide data with an increased dynamic range which can then be used to divide the pixel array into a plurality of regions, which may also be referred to as ‘clusters’ (in block 304).

Having divided the pixel array into regions (in block 304), based on the pre-capture data (received in block 302), an exposure time (and potentially other exposure parameters such as analog gain, digital gain and/or optics aperture) is allocated to each region (block 306). The exposure time is allocated based on the dynamic range in the pre-capture data and may be allocated from a pre-defined set of possible exposure times or may be calculated dynamically. In an example, the control circuitry 208 (and more particularly, the exposure setting module 212) may have a pre-defined set of two or three pre-defined exposure times (although the particular number of exposure times in the set may be highly scene/camera/use case dependent) and each region may be allocated one of these exposure times (in block 306), e.g. the darkest region in the pre-capture data may be allocated the longest capture time from the set of pre-defined exposure times and the brightest (i.e. least dark) region in the pre-capture data may be allocated the shortest capture time from the same set of pre-defined exposure times.

In various examples, instead of storing a plurality of pre-defined exposure times, one or more exposure time ratios may be stored and used to calculate additional exposure times from the standard exposure time which may be calculated in the standard way. If the “normal” exposure time (based on the pre-capture data) is X, a region which is identified as being dark (e.g. in comparison to other regions) may be allocated an exposure time of 2X and a region which is identified as being light (e.g. in comparison to other regions) may be allocated an exposure time of X/2.

The control circuitry 208 then triggers the image capture by the pixels in the array for the set exposure times (block 308, e.g. in response to the user pressing the button or they may have pressed the button at an earlier point in the flow diagram of FIG. 3) and reads the data from the pixels (block 310) using the ADCs 210. During the exposure time, charge accumulates within each pixel (where the amount of accumulated charge is dependent upon the incident light level) and it is this charge that is read by the control circuitry. As described in more detail below, the end of the exposure time may correspond to the time that the pixel data is read or alternatively, at the end of the exposure time, the accumulated charge in each pixel may be stored in a light-shielded region of the pixel such that the pixel data can be read subsequently. Consequently, the exposure time for a pixel may be controlled (in block 308) by controlling when the exposure starts and/or stops and/or when the accumulated charge may be transferred to a light-shielded region.

As shown in FIG. 3, the data that is read from each pixel may be compensated in total exposure (block 312) i.e. exposure time multiplied by analog and digital gains. However, in some implementations, no gain compensation may be required (i.e. block 312 may be omitted) e.g. when the dynamic range exceeds the bit depth.

As noted above, the variation of the exposure time (in block 308) may be implemented in many different ways, e.g. by adjusting only the end time of an exposure (where the end time may correspond to when the pixel is read or when the accumulated charge is transferred to a light-shielded region), by adjusting only the start time of the exposure (where the start time may correspond to when the pixel is reset) or by adjusting both the start and the end times and four examples are described below. Each of these examples results in a different hardware implementation of the image sensor system 200 and further examples may include aspects of any two or more of the examples described.

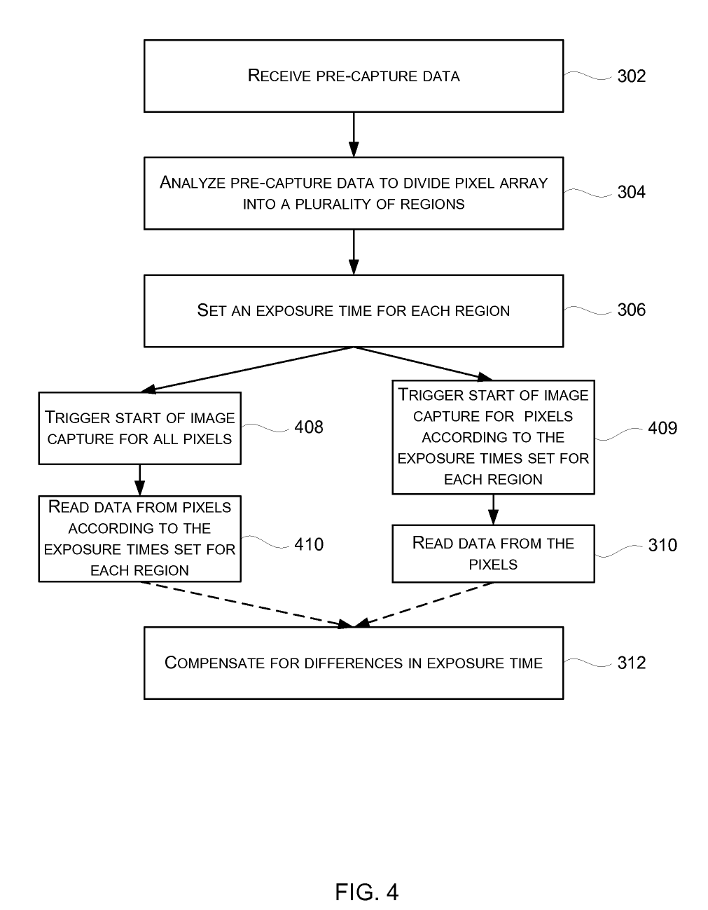

In a first example implementation, as shown in the flow diagram in FIG. 4, separate readout logic (e.g. a separate ADC 210) is provided for each pixel 202 in the pixel array 206. This enables the control circuitry to read out the pixel data from each pixel independently and so control the exposure time for each pixel by setting the read out time for each pixel. As shown in FIG. 4, the start of image capture may be triggered at the same time for all the pixels (block 408) and then pixel data is read according to the previously set exposure times for each region (block 410).

Alternatively, separate trigger logic is provided for each pixel 202 in the pixel array 206. This enables the control circuitry to trigger the start of image capture independently for each pixel and so control the exposure time for each pixel by setting the start time for each pixel. As shown in FIG. 4, the start of image capture may be triggered according to the previously set exposure times for each region (block 409) and then the pixels may be read in the conventional manner (in block 310).

In various examples, the read out time may be specified using a mask which is generated and stored by the control circuitry (in block 306) and which defines all the different exposure times in the frame prior to capture (i.e. based on the pre-capture data received in block 302). Referring back to the example in FIG. 1, this mask may define three regions 101-103 with region 101 having the shortest exposure time and region 103 having the longest exposure time. Alternatively, instead of storing a mask, the preview frame may be stored and the exposure parameters calculated on the fly (e.g. in response to the button being pressed, e.g. such that blocks 304-306 occurs immediately before or at the same time as block 408). This first example implementation may be easier to implement than the other example implementations described below.

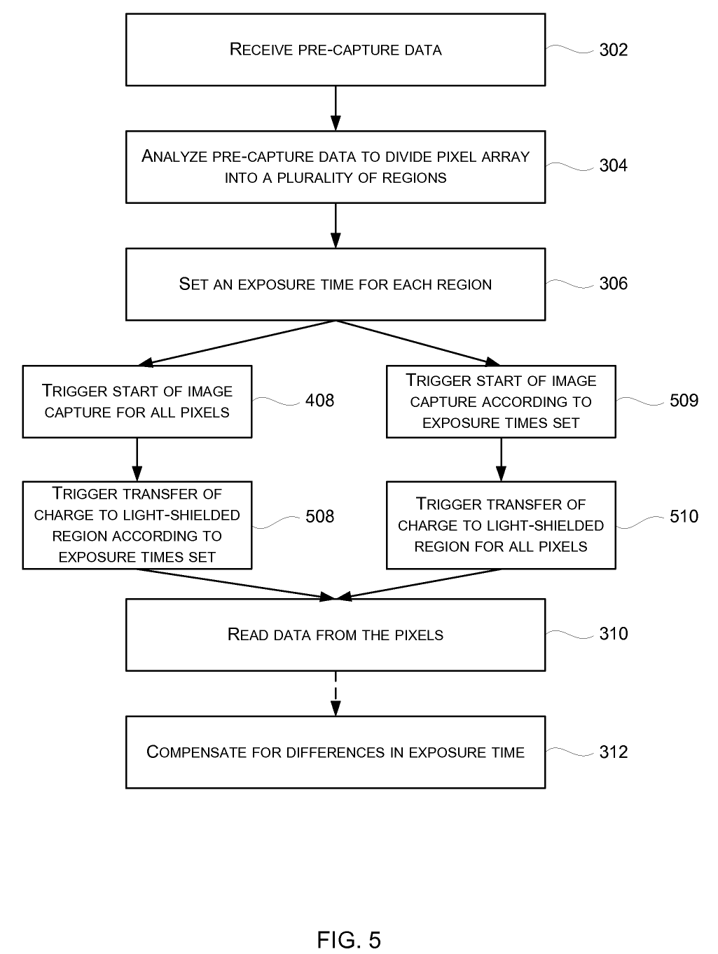

In a second example implementation, as shown in the flow diagram in FIG. 5, a global shutter is provided for each pixel which provides a light-shielded region of the pixel to which the accumulated charge is transferred. The pixel data is therefore stored in the charge domain (in the light-shielded region of the pixel) until it is read out and the read out may use a conventional rolling shutter arrangement with one ADC per column in the pixel array (and pixels being read line by line) or there may be a larger number of ADCs enabling more than one pixel in a column to be read at the same time.

In this second example implementation, the control circuitry controls the global shutter, i.e. it controls when the accumulated charge is transferred to the light-shielded region, on a per-pixel or per-group-of-pixels basis. This requires one or more additional connections to each pixel to trigger the transfer of charge to the light-shielded region at the end of the exposure time for the particular pixel (block 508) and again a mask may be used to define when the charge is transferred for each of the pixels. Alternatively, the start of the exposure time may be controlled individually on a per-pixel or per-group-of-pixels basis (block 509) and a single trigger may be used to control when the accumulated charge is transferred to the light-shielded region for all pixels (block 510).

In a third example implementation, additional logic and additional control connections are provided to enable reading of only a proper subset of the pixels in the line. This enables pixels within a line to be read in groups or phases and can be described with reference to FIGS. 1, 6 and 7. The control circuitry may generate and store (in block 306) a mask which defines the different exposure times in the frame prior to capture (i.e. based on the pre-capture data received in block 302). Referring back to the example in FIG. 1, this mask may define three regions 101-103 with region 101 having the shortest exposure time and region 103 having the longest exposure time.

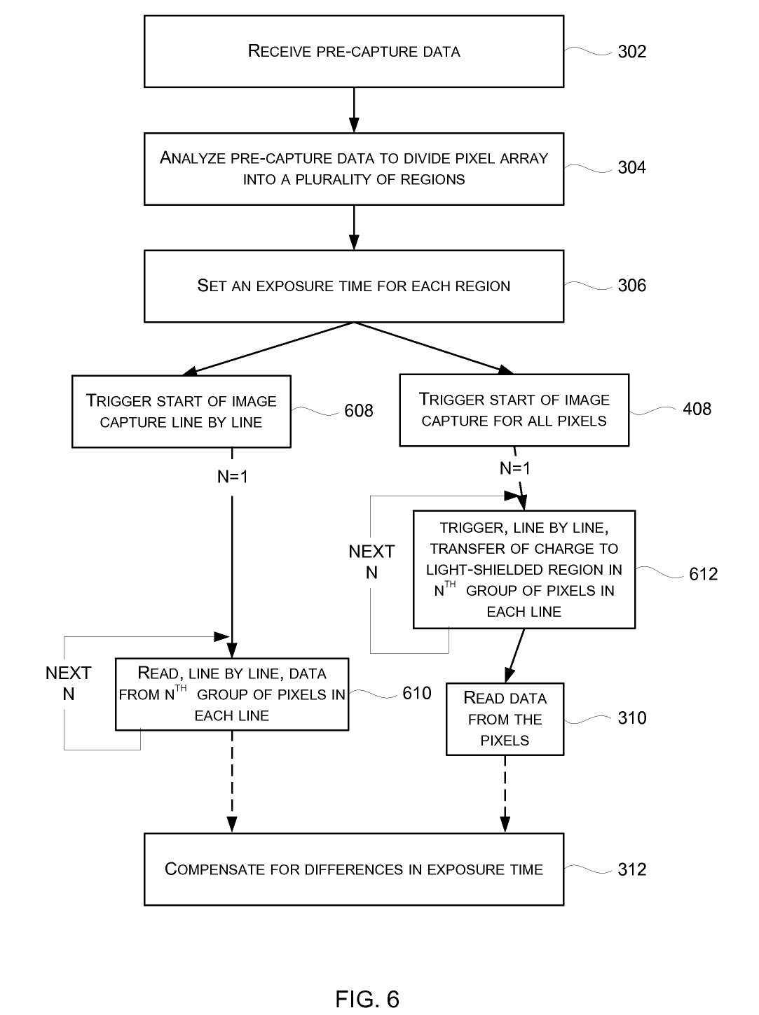

In the third example implementation, as shown in the flow diagram in FIG. 6, image capture may be triggered line by line (block 608), as is standard for rolling shutter, i.e. such that the exposure starts for all the pixels in the first line, then for all the pixels in the second line, etc. Once all the lines have been cycled through (e.g. all 6 lines in the example shown in FIG. 1), data is then read from the pixels on a line by line basis (block 610); however, unlike standard rolling shutter, all the pixels from the line are not read and instead the mask is used to identify which pixels are read, e.g. such that in a first pass a first group of pixels in each line is read, followed by a second pass in which a second group of pixels in each line is read, etc. A group of pixels in a line may comprise none, one or more pixels and the N^{th} group in a line may comprise the same number of pixels or a different number of pixels as the N^{th} groups in other lines.

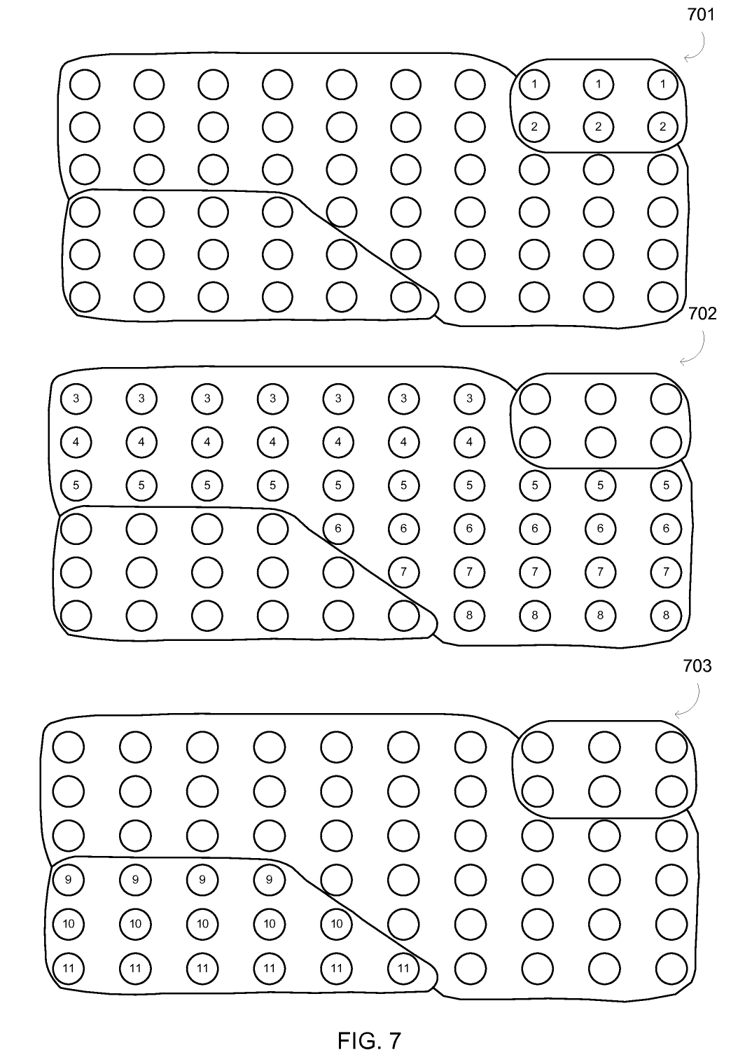

As shown in FIG. 7, which corresponds to the example shown in FIG. 1 and described above, in a first pass 701 (which corresponds to the shortest exposure time determined in block 306), when reading from the first line (in block 610), only the last three pixels are read (as indicated by the ‘1’s in FIG. 7) and when reading from the second line, only the last three pixels are read (as indicated by the ‘2’s in FIG. 7). In this first pass 701, no pixels are read from any of the remaining four lines (i.e. the first group of pixels in each of these four lines comprises no pixels).

In the second pass 702 (block 610, which again reads none, one or more pixels from each line, starting at one extreme and traversing each line in the array in turn) which corresponds to the next shortest exposure time (as determined in block 306), the first seven pixels are read from the first line (as indicated by the ‘3’s in FIG. 7), followed by the first 7 pixels in the second line (‘4’s), all the pixels in the third line (‘5’s), the last 6 pixels in the fourth line (‘6’s), the last 5 pixels in the fifth line (‘7’s) and finally the last 4 pixels in the sixth line (‘8’s).

In a third pass 703 (which corresponds to the longest exposure time determined in block 306), no pixels are read from any of the first three lines, then the first 4 pixels in the fourth line are read (as indicated by the ‘9’s in FIG. 7), followed by the first 5 pixels in the fifth line (‘10’s) and finally the first 6 pixels in the sixth line (‘11’s).

Although this third example implementation is described with reference to rolling shutter, this is by way of example only and the technique may also be used in combination with a global shutter, i.e. with each pixel having a light-shielded region and a plurality of triggers per pixel line being used to cause the charge accumulated in each pixel to be transferred into the light-shielded region of the particular pixel (block 612). Where a global shutter is used, in the first pass (in block 612), the charge is transferred in the last three pixels of the first line and then the last three pixels in the second line (and not in any of the pixels in the subsequent lines) and in the second pass (in block 612), the charge is transferred in the first 7 pixels in the first line, followed by the first 7 pixels in the second line, etc. Where global shutter is used in this way, the end of the exposure time is decoupled from the reading operation (in block 310) which can occur subsequently and the pixels may be read in any order without it affecting the data which is read.

In the third example implementation, the pixel area (or sensor) is read more than once, i.e. once for each different exposure time which has been determined (in block 306); however, each pixel is still only read once (i.e. once per captured image). A mask may be used to control which pixels in a line are read in each read pass 701-703 (as described above). Furthermore, where rolling shutter is used, the time at which a pixel will be read (in block 610) is pre-defined and where global shutter is used, the time at which the charge is transferred in a pixel to the light-shielded region (in block 612) is pre-defined, where the term pre-defined is used here to mean that it is determined before the start of the exposure (based on the analysis of the pre-capture data) and is not, for example, determined during the exposure (e.g. by repeatedly reading each pixel).

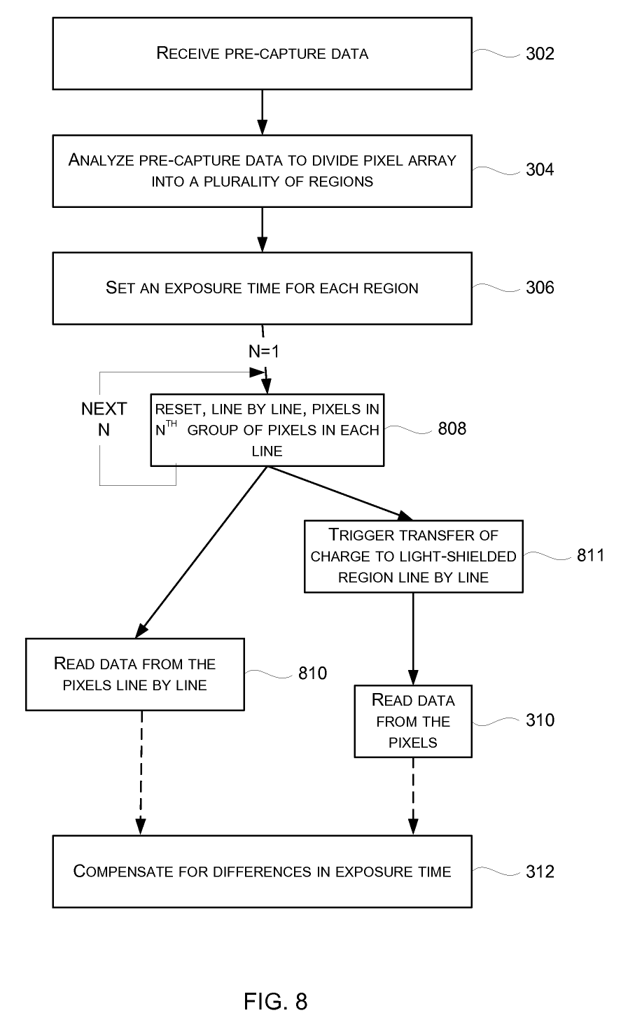

In a fourth example implementation, additional logic is provided to enable groups of pixels within a line to be reset at different times (block 808 e.g. like in the third example implementation, except for pixel reset rather than reading pixel data). In such a fourth example implementation, as shown in the flow diagram in FIG. 8, and referring back to the example described above with reference to FIG. 1, in a first pass (in block 808) those pixels in the third region 103 are reset first (e.g. the first 4 pixels in the fourth line, followed by the first 5 pixels in the fifth line and then the first 6 pixels in the sixth line), followed by the pixels in the second region 102 and then the pixels in the first region 101 (which has the shortest exposure time). The pixels can then be read (block 810) or the charge transferred, (block 811, in the case of global rather than rolling shutter) in the normal way, e.g. line by line, with all the pixels in the line being read (in block 810).

In the fourth example implementation, the pixel array (or sensor) is reset more than once (in block 808), i.e. once for each different exposure time which has been determined (in block 306); however, each pixel is still only reset once. A mask may be used to control which pixels in a line are reset in each reset pass (in block 808) and additional control connections may be provided to implement this.

In many of the example implementations described above, additional connections are required to each pixel. Consequently, backside-illuminated pixels may be used, which allow additional metal layers, without impacting the optical performance of the device (i.e. without occluding the sensor).

In any of the examples described above, the exposure setting module 212 may be free to group pixels into regions in any way (based on the pre-capture data) or alternatively, the exposure setting module 212 may be constrained by the hardware in some way. For example, pixels in a line may be grouped in pairs (e.g. pixels 1 and 2, pixels 3 and 4, pixels 5 and 6, etc.) and the exposure setting module 212 may allocate pairs of pixels to regions (i.e. such that both pixels in a pair have the same exposure time, which may be different from an adjacent pair of pixels in the line). This may reduce the complexity of the hardware.

In the methods and apparatus described above, the active time during which the photons are captured by the pixels is varied to provide a different exposure time for different groups of pixels within the same line in the pixel array. This is more effective than just changing the size of an aperture and more efficient than just adjusting the gain on different pixels.

The methods and apparatus described above enable the exposure time to be set to an optimal value for all pixels without reducing the resolution of the resulting image. The methods described herein significantly improve the quality of the resulting image (by reducing ghosting effects) where the objects and/or camera are moving.

Although the present examples are described and illustrated herein as being implemented in an image sensor system as shown in FIG. 2, the system described is provided as an example and not a limitation. As those skilled in the art will appreciate, the present examples are suitable for application in a variety of different types of image sensor systems. For example, although FIG. 2 shows a rectangular, regular array of pixels 206, in other examples, the array may not be rectangular and/or it may be non-planar and/or the pixels may not be regularly spaced. The methods described herein may also be used where the pixels are not arranged in straight lines and in the case of per-pixel exposure times, for irregular arrays of pixels.

The image sensor system described above may be used in any application, e.g. any digital camera or imaging systems. For some applications, the ability to correctly locate and identify objects in an image, even if they are in a dark, shadowy region, may be safety critical and so the techniques described herein may be particularly useful. Examples of such applications include vision systems in cars or other vehicles (e.g. which need to detect lines on a road or road signs in order to control the vehicle or provide warnings to the driver).

A first further example provides an image sensor system comprising: a plurality of image sensing pixels arranged in lines; and control circuitry configured to set an exposure time for the image sensing pixels in a line such that when capturing a single image, a first group of pixels in the line has a first exposure time and a second group of pixels in the same line has a second exposure time.

A second further example provides an image sensor system comprising: a plurality of image sensing pixels arranged in lines; and control circuitry configured to set an exposure time for each of the plurality of image sensing pixels such that a first group of pixels in a line has a first exposure time and a second group of pixels in the same line has a second exposure time.

A third further example provides an image sensor system comprising: a plurality of image sensing pixels arranged in lines; and means for setting an exposure time for the image sensing pixels in a line such that when capturing a single image, a first group of pixels in the line has a first exposure time and a second group of pixels in the same line has a second exposure time.

In any of the first, second and third further examples, the control circuitry may be further configured to receive and analyze pre-capture data, to divide the plurality of image sensing pixels into a plurality of regions based on analysis of the pre-capture data and to set an exposure time for each region, wherein the first group of pixels is in a first region from the plurality of regions and the second group of pixels is in a second region from the plurality of regions.

In any of the first, second and third further examples, the control circuitry may additionally, or instead, be further configured to set an exposure time for each of the image sensing pixels in the plurality of image sensing pixels and to generate and store a mask specifying an exposure time for each image sensing pixel in the plurality of image sensing pixels and subsequently to use the mask to control exposure time during image capture.

In any of the first, second and third further examples, the control circuitry may comprise readout logic for each of the plurality of image sensing pixels and is further configured to set an exposure time for each of the image sensing pixels in the plurality of image sensing pixels and, for each image sensing pixel, to read pixel data from the image sensing pixel according to the exposure time set for that image sensing pixel.

In any of the first, second and third further examples, the control circuitry may comprise trigger logic for each of the plurality of image sensing pixels and may be further configured to set an exposure time for each of the image sensing pixels in the plurality of image sensing pixels and, for each image sensing pixel, to trigger a start of image capture by the image sensing pixel according to the exposure time set for that image sensing pixel.

In a first embodiment of any of the first, second and third further examples, each image sensing pixel may comprise a light-shielded region for storing accumulated charge and the control circuitry may be further configured to set an exposure time for each of the image sensing pixels in the plurality of image sensing pixels and, for each image sensing pixel, to trigger transfer of accumulated charge to the light-shielded region in the image sensing pixel according to the exposure time set for that image sensing pixel.

In a second embodiment of any of the first, second and third further examples, the control circuitry may be further configured to read pixel data from the first group of pixels in one read operation at a time specified by the first exposure time and to read pixel data from the second group of pixels in a separate read operation at a time specified by the second exposure time. When capturing an image, each pixel may be read only once.

In a third embodiment of any of the first, second and third further examples, each image sensing pixel may comprise a light-shielded region for storing accumulated charge and wherein the control circuitry may be further configured to trigger transfer of accumulated charge to the light-shielded region in each of the first group of pixels in at a time specified by the first exposure time and to trigger transfer of accumulated charge to the light-shielded region in each of the second group of pixels at a time specified by the second exposure time.

In a fourth embodiment of any of the first, second and third further examples, the control circuitry may be further configured to reset each of the first group of pixels in one reset operation at a time specified by the first exposure time and to reset each of the second group of pixels in a separate reset operation at a time specified by the second exposure time.

In any of the first, second and third further examples, the image sensing pixels may be backside-illuminated sensors.

In any of the first, second and third further examples, the plurality of image sensing pixels may be arranged in straight lines or zig-zag lines or curved lines.

A fourth further example provides a method of capturing a single image in an image sensor system comprising a plurality of image sensing pixels arranged in lines, the method comprising: defining a first exposure time for a first group of image sensing pixels in a line and a second exposure time for a second group of image sensing pixels in the line; and capturing the image using the defined exposure times for each image sensing pixel.

The method may further comprise: receiving pre-capture data; and dividing the plurality of image sensing pixels into a plurality of regions based on analysis of the pre-capture data, wherein the first group of image sensing pixels is in a first region and the second group of image sensing pixels is in a second region.

The method may further comprise: defining an exposure time for each of the plurality of regions, wherein the first exposure time is defined for the first region and the second exposure time is defined for the second region.

Capturing the image using the defined exposure times for each image sensing pixel may comprise: resetting pixels and/or reading pixel data from each image sensing pixel according to the defined exposure time for each image sensing pixel.

Reading pixel data from each image sensing pixel according to the defined exposure time for each image sensing pixel may comprise: in a first read operation, reading pixel data from the first group of pixels at a time specified by the first exposure time; and in a second read operation, reading pixel data from the second group of pixels at a time specified by the second exposure time.

Resetting pixels and/or reading pixel data from each image sensing pixel according to the defined exposure time for each image sensing pixel may comprise: in a first reset operation, resetting the first group of pixels at a time specified by the first exposure time and in a second reset operation, resetting the second group of pixels at a time specified by the second exposure time.

In the method, when capturing a single image, each pixel may be reset and read only once.

Capturing the image using the defined exposure times for each image sensing pixel may comprise: triggering the transfer of accumulated charge in each image sensing pixel to a light-shielded region in the image sensing pixel according to the defined exposure time for each image sensing pixel.

Triggering the transfer of accumulated charge in each image sensing pixel to a light-shielded region in the image sensing pixel according to the defined exposure time for each image sensing pixel may comprise: in a first triggering operation, triggering the transfer of accumulated charge in each image sensing pixel in the first group of pixels at a time specified by the first exposure time; and in a second triggering operation, triggering the transfer of accumulated charge in each image sensing pixel in the second group of pixels at a time specified by the second exposure time.

Capturing the image using the defined exposure times for each image sensing pixel may comprise: resetting each image sensing pixel according to the defined exposure time for each image sensing pixel.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An image sensor system comprising:
a plurality of image sensing pixels arranged in lines; and
control circuitry configured to:
receive and analyze pre-capture data;
divide the plurality of image sensing pixels into a plurality of regions based on analysis of the pre-capture data such that a first group of the image sensing pixels is in a first region of the plurality of regions and a second group of image sensing pixels is in a second region of the plurality of regions;
set an exposure time for each region based on the analysis of the pre-capture data, the exposure time being set such that when capturing a single image, a first pixel in a line has a first exposure time and a second pixel in the same line has a second exposure time, the first pixel being in the first region and the second pixel being in the second region.

2. (canceled)

3. An image sensor system according to claim 1, wherein the control circuitry is further configured to set an exposure time for each of the image sensing pixels in the plurality of image sensing pixels and to generate and store a mask specifying an exposure time for each image sensing pixel in the plurality of image sensing pixels and subsequently to use the mask to control exposure time during image capture.

4. An image sensor system according to claim 1, wherein the control circuitry comprises readout logic for each of the plurality of image sensing pixels and is further configured to set an exposure time for each of the image sensing pixels in the plurality of image sensing pixels and, for each image sensing pixel, to read pixel data from the image sensing pixel according to the exposure time set for that image sensing pixel.

5. An image sensor system according to claim 1, wherein the control circuitry comprises trigger logic for each of the plurality of image sensing pixels and is further configured to set an exposure time for each of the image sensing pixels in the plurality of image sensing pixels and, for each image sensing pixel, to trigger a start of image capture by the image sensing pixel according to the exposure time set for that image sensing pixel.

6. An image sensor system according to claim 1, wherein each image sensing pixel comprises a light-shielded region for storing accumulated charge and the control circuitry is further configured to set an exposure time for each of the image sensing pixels in the plurality of image sensing pixels and, for each image sensing pixel, to trigger transfer of accumulated charge to the light-shielded region in the image sensing pixel according to the exposure time set for that image sensing pixel.

7. An image sensor system according to claim 1, wherein the control circuitry is further configured to read pixel data from the first group of pixels in one read operation at a time specified by the first exposure time and to read pixel data from the second group of pixels in a separate read operation at a time specified by the second exposure time.

8. An image sensor system according to claim 7, wherein in capturing an image, each pixel is read only once.

9. An image sensor system according to claim 1, wherein each image sensing pixel comprises a light-shielded region for storing accumulated charge and wherein the control circuitry is further configured to trigger transfer of accumulated charge to the light-shielded region in each of the first group of pixels in at a time specified by the first exposure time and to trigger transfer of accumulated charge to the light-shielded region in each of the second group of pixels at a time specified by the second exposure time.

10. An image sensor system according to claim 1, wherein the control circuitry is further configured to reset each of the first group of pixels in one reset operation at a time specified by the first exposure time and to reset each of the second group of pixels in a separate reset operation at a time specified by the second exposure time.

11. An image sensor system according to claim 1, wherein the image sensing pixels are backside-illuminated sensors.

12. An image sensor system according to claim 1, wherein the plurality of image sensing pixels are arranged in straight lines.

13. A method of capturing a single image in an image sensor system comprising a plurality of image sensing pixels arranged in lines, the method comprising:
receiving pre-capture data;
analyzing the pre-capture data;
dividing the plurality of image sensing pixels into a plurality of regions based on the analysis of the pre-capture data;
defining, based on the analysis of the pre-capture data, a first exposure time for a first region of the plurality of regions and a second exposure time for a second region of the plurality of regions; and
capturing the image using the first exposure time or the second exposure time, respectively, for each image sensing pixel.

14. (canceled)

15. (canceled)

16. A method according to claim 13, wherein capturing the image using the first exposure time and the second exposure time for each image sensing pixel comprises one or more of:
resetting pixels from each image sensing pixel according to the first exposure time or the second exposure time, respectively, or
reading pixel data from each image sensing pixel according to the first exposure time or the second exposure time, respectively.

17. A method according to claim 16, wherein resetting pixels from each image sensing pixel according to the first exposure time or the second exposure time, respectively, includes
in a first reset operation, resetting the first group of image sensing pixels at a time specified by the first exposure time and in a second reset operation, resetting the second group of image sensing pixels at a time specified by the second exposure time.

18. A method according to claim 17, wherein when capturing a single image, each pixel is reset only once.

19. A method according to claim 13, wherein capturing the image using the defined exposure times for each image sensing pixel comprises:
triggering the transfer of accumulated charge in each image sensing pixel to a light-shielded region in the image sensing pixel according to the defined exposure time for each image sensing pixel.

20. An image sensor system comprising:
a plurality of image sensing pixels arranged in lines; and
control circuitry configured to:
receive and analyze pre-capture data;
divide the plurality of image sensing pixels into a plurality of regions based on analysis of the pre-capture data such that a first group of the image sensing pixels is in a first region of the plurality of regions and a second group of image sensing pixels is in a second region of the plurality of regions;
set an exposure time for each region based on the analysis of the pre-capture data, the exposure time being set such that a first pixel in a line has a first exposure time and a second pixel in the same line has a second exposure time, the first pixel being in the first region and the second pixel being in the second region.

21. A method as claim 13 recites, wherein
defining the first exposure time for the first region includes defining the first exposure time for a first group of image sensing pixels in a line, and
defining the second exposure time for the second region includes defining the second exposure time for a second group of image sensing pixels in the same line.

22. A method according to claim 16, wherein reading pixel data from each image sensing pixel according to the first exposure time or the second exposure time, respectively, includes:
in a first read operation, reading pixel data from the first group of image sensing pixels at a time specified by the first exposure time and in a second read operation, reading pixel data from the second group of image sensing pixels at a time specified by the second exposure time.

23. A method according to claim 22, wherein when capturing a single image, each pixel is read only once.
